(19) United States
(12) Patent Application Publication
(10) Pub. No.: US 2024/0164978 A1
(43) Pub. Date: May 23, 2024

(54) MASSAGING DEVICE

(71) Applicant: Shenzhen Heze Technology Co., Ltd., Shenzhen (CN)

(72) Inventors: Minchao He, Shenzhen (CN); Yongqing Wang, Shenzhen (CN); Botian Huang, Shenzhen (CN)

(21) Appl. No.: 18/106,510

(22) Filed: Feb. 7, 2023

(30) Foreign Application Priority Data
Nov. 22, 2022 (CN) 202223123808.8

(51) Int. Cl. A61H 7/00

(52) U.S. Cl. CPC A61H 7/005; A61H 7/007; A61H 2201/0207; A61H 2201/0214; A61H 2201/0221; A61H 2201/1215; A61H 2201/1654

(57) ABSTRACT

The present disclosure provides a massaging device which includes a flexible body defining a first opening and a massaging portion communicated with the first opening, and a driving assembly configured to drive the flexible body to reciprocate and rotate simultaneously. The massaging device of the present disclosure has a good massaging effect.

### CROSS REFERENCE TO RELATED APPLICATIONS

The present application claims the benefit of Chinese Patent Application No. 202223123808.8 filed on Nov. 22, 2022, the contents of which are incorporated herein by reference in their entirety.

### FIELD

The present disclosure generally relates to a massaging device.

### BACKGROUND

With the accelerated pace of life, working pressures on people are increased. After daily working, a person may be tired, various portions of a body may ache. In order to relieve fatigue and soreness, people may take a variety of massaging devices to massage the body. People's fingers may be stiff and swollen after typing for a long time, and people can manually use the massaging device to massage the fingers. After a long massage, the arm may be ache, resulting a poor massaging effect.

### SUMMARY

The present disclosure provides a massaging device, which includes a flexible body defining a first opening and a massaging portion communicated with the first opening, and a driving assembly configured to drive the flexible body to reciprocate and rotate simultaneously.

### BRIEF DESCRIPTION OF THE DRAWINGS

Implementations of the present disclosure will now be described, by way of embodiment, with reference to the attached figures It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structure diagram of a massaging device according to a first embodiment of the present disclosure.

FIG. 2 is an exploded diagram of the massaging device of FIG. 1.

FIG. 3 is a cross sectional diagram of the massaging device of FIG. 1.

FIG. 4 is a structure diagram of a top cover and a temperature adjusting element of the massaging device of FIG. 2.

FIG. 5 is a structure diagram of a flexible body of the massaging device of FIG. 2.

FIG. 6 is another structure diagram of the flexible body of the massaging device of FIG. 2.

FIG. 7 is a structure diagram of a support of the massaging device of FIG. 2.

FIG. 8 is another structure diagram of the support of the massaging device of FIG. 2.

FIG. 9 is a structure diagram of an inner housing, a first guiding element, and a driving assembly of the massaging device of FIG. 2.

FIG. 10 is a structure diagram of the inner housing and the first guiding element of the massaging device of FIG. 2.

FIG. 11 is a structure diagram of a first movable element of the massaging device of FIG. 2.

FIG. 12 is another structure diagram of the first movable element of the massaging device of FIG. 2.

FIG. 13 is a further structure diagram of the first movable element of the massaging device of FIG. 2.

FIG. 14 is a structure diagram of a protective sleeve of the massaging device of FIG. 2.

FIG. 15 is a structure diagram of a mounting frame of the massaging device of FIG. 2.

FIG. 16 is another structure diagram of the mounting frame of the massaging device of FIG. 2.

FIG. 17 is a structure diagram of a massaging device according to a second embodiment of the present disclosure.

FIG. 18 is a cross sectional diagram of the massaging device of FIG. 17.

FIG. 19 is a structure diagram of a part of the massaging device of FIG. 17.

FIG. 20 is a cross sectional diagram of the part of the massaging device of FIG. 19.

FIG. 21 is an exploded diagram of the part of the massaging device of FIG. 19.

FIG. 22 is a structure diagram of a massaging device according to a third embodiment of the present disclosure.

FIG. 23 is an exploded diagram of the massaging device of FIG. 22.

FIG. 24 is another exploded diagram of the massaging device of FIG. 22.

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

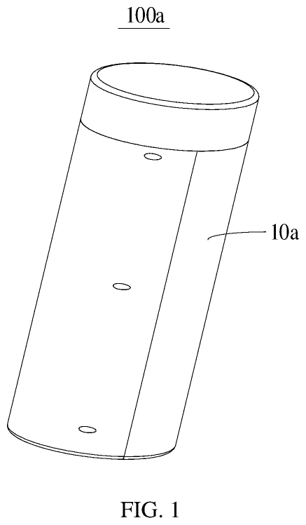

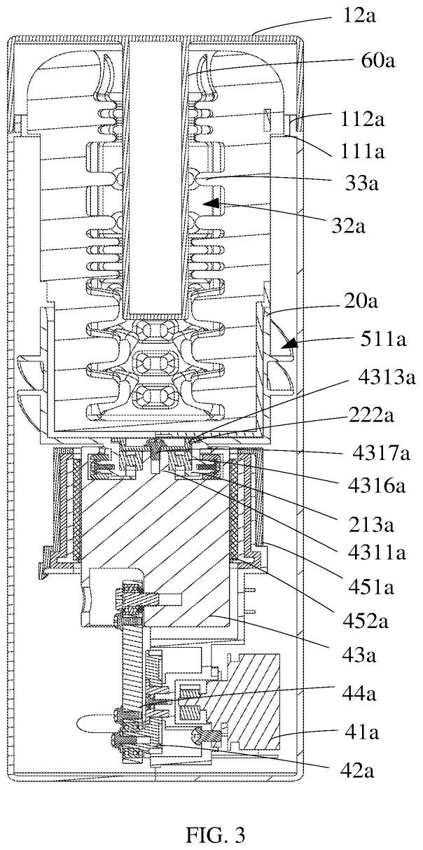

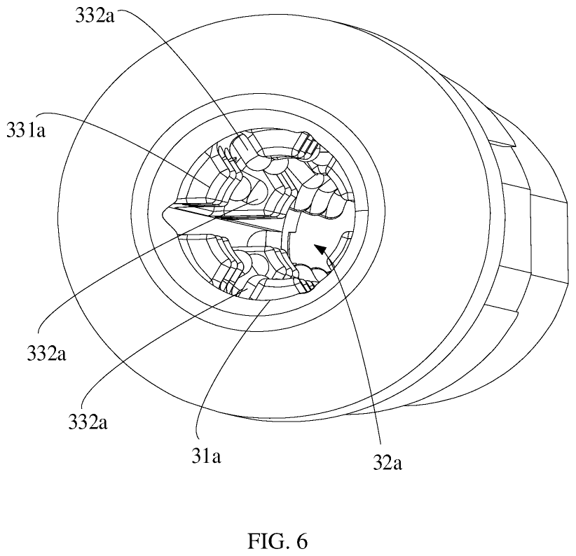

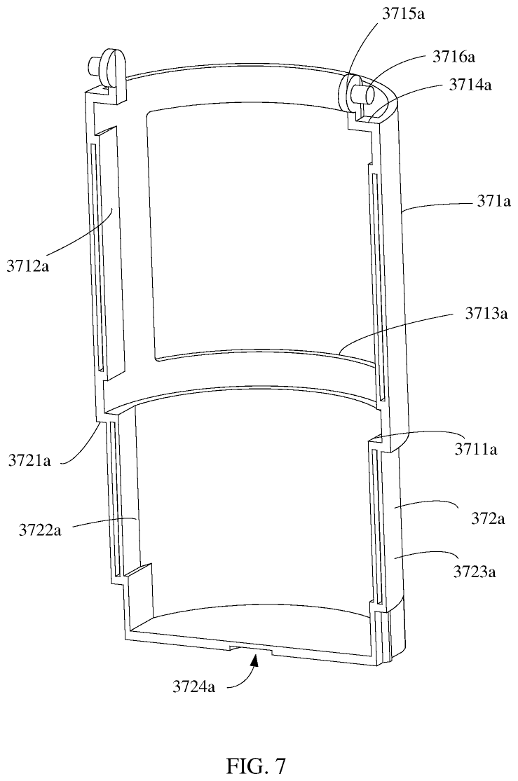

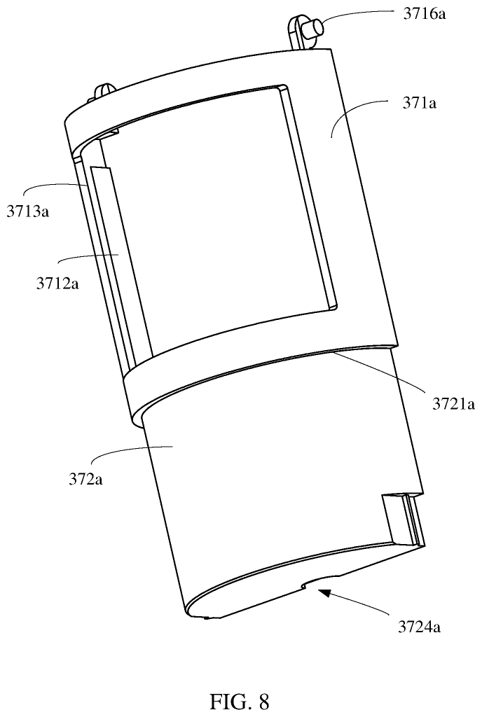

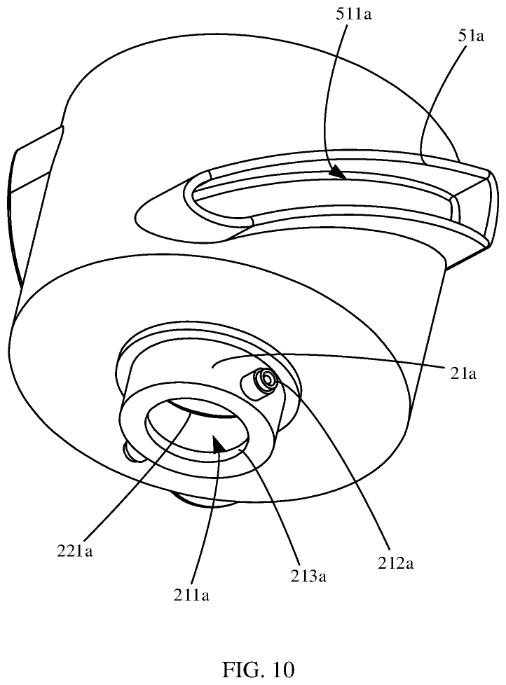

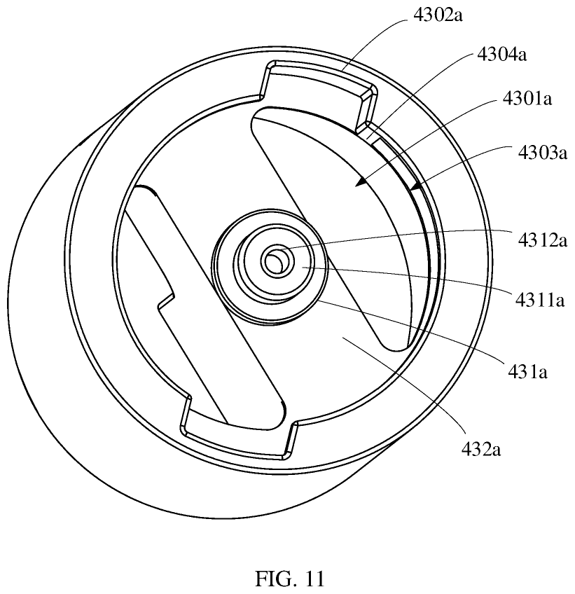

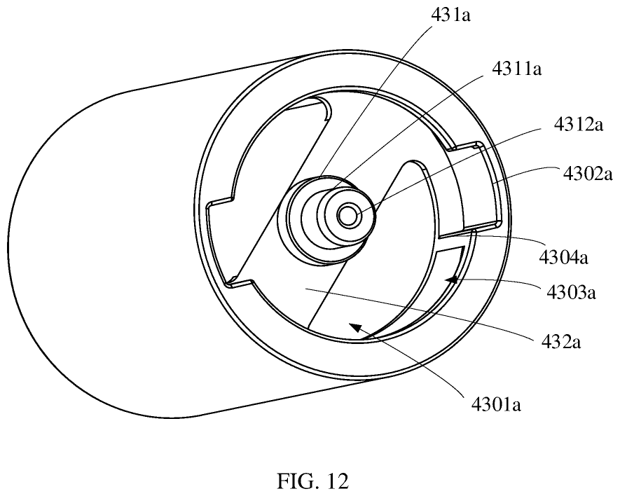

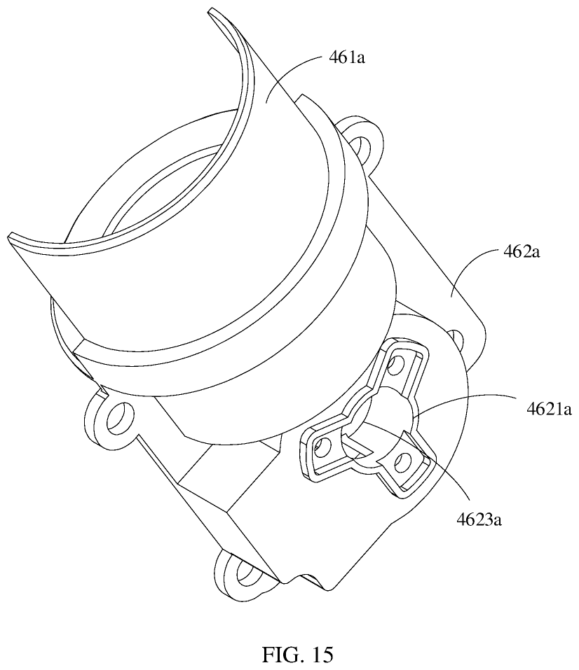

Referring to FIGS. 1-16, the present disclosure provides a massaging device 100a for massaging fingers or other parts of the human body. The massaging device 100a includes a flexible body 30a and a driving assembly 40a. The flexible body 30a defines a first opening 31a and a massaging portion 32a communicated with the first opening 31. The driving assembly 40a is used to drive the flexible body 30a to reciprocate and rotate simultaneously. The driving assembly 40a can drive the flexible body 30a to reciprocate and rotate at the same time, so that the fingers or other parts in the massaging portion 32a of the flexible body 30a can be massaged very well. The massaging portion 32a may be massaging hole (including a through hole or a blind hole), a massaging groove, a massaging cavity, or a massaging space. It should be noted that, in some embodiments, the flexible body 30a can reciprocate at first and then start to rotate while still reciprocating, or the flexible body 30a can rotate at first and then start to reciprocate while still rotating. That is to say, the flexible body 30a maybe reciprocate and rotate at the same time only in a given period, but not at whole process.

Referring to FIGS. 1-3, the massaging device 100a further includes an outer housing 10a and an inner housing 20a. The inner housing 20a, the flexible body 30a, and the driving assembly 40a are all received in the outer housing 10a. The inner housing 20a is connected between the flexible body 30a and the driving assembly 40a.

The outer housing 10a may be made of silica gel, rigid plastic, or flexible plastic. The outer housing 10a includes two sub housings 11a and an upper cover 12a. The upper cover 12a covers the two sub housings 11a detachably, and is capable of exposing or covering the first opening 31a and the massaging portion 32a. The two sub housings 11a are detachably connected to facilitate the installations of the flexible body 30a and the driving assembly 40a. One end of the outer housing 10a defines a second opening 111a communicated with the first opening 31a. The upper cover 12a and the sub housings 11a enclose a receiving space 112a, in which the flexible body 30a and the driving assembly 40a are accommodated.

The flexible body 30a may be made of flexible materials such as silica gel or flexible plastic. The flexible body 30a further includes at least one massaging protrusion 33a protruded from the inner wall of the massaging portion 32a, and a cross section of the massaging protrusion 33a may be cylindrical shaped, trapezoidal shaped, triangular shaped, arc shaped, or irregular shaped. In a specific embodiment, the at least one massaging protrusion 33a includes a plurality of of first protrusions 331 spaced from each other and a plurality of second protrusions 332a spaced from each other, the first protrusions 331a are adjacent to the first opening 31a, and the second protrusions 332a are arranged below the first protrusions 331a; or an area adjacent to the first opening 31a is provided with the first protrusions 331, and an area adjacent to the bottom of the flexible body 30a is also provided with the first protrusions 331a, and the second protrusions 332a are arranged in the middle area of the flexible body 30a, that is, the second protrusions 332a are arranged between the two kinds first protrusions 331a. The first protrusions 331a and the second protrusions 332a can be staggered to increase the massaging force and massaging effect.

In an embodiment, the lower end of the flexible body 30a is fixedly connected with the inner housing 20a, and the upper end of the flexible body 30a is connected with an area of the outer housing 10a adjacent to the second opening 111a, so that the flexible body 30a can reciprocate and rotate with the inner housing 20a. In another embodiment, the lower end of the flexible body 30a is fixedly connected with the inner housing 20a, the upper end of the flexible body 30a is not connected with the outer housing 10a, and the flexible body 30a can reciprocate and rotate with the inner housing 20a. In a further embodiment, the flexible body 30a is integrally fixed to the inner housing 20a, and the upper end of the flexible body 30a is not connected with the outer housing 10a, so that the flexible body 30a can reciprocate and rotate with the inner housing 20a. Specifically, the inner housing 20a defines a receiving cavity 22a, the depth of the receiving cavity 22a is consistent with the height of the flexible body 30a, the flexible body 30a can be completely received in the receiving cavity 22a, and the flexible body 30a can reciprocate and rotate with the inner housing 20a.

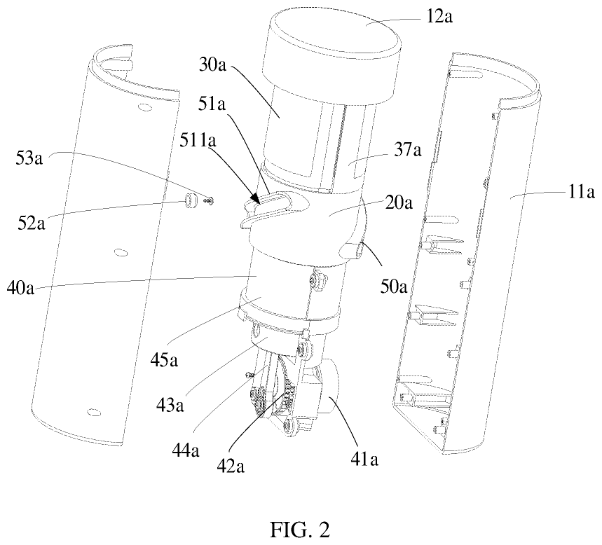

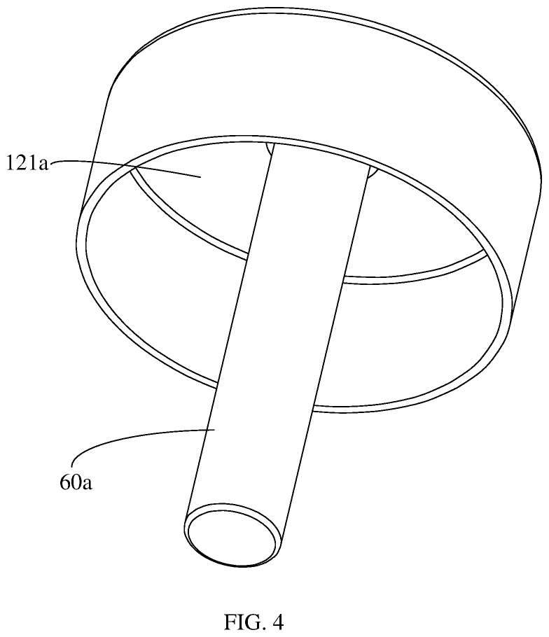

Please referring to FIGS. 2 and 4, the massaging device 100a further includes a temperature adjusting element 60a, the temperature adjusting element 60a is embedded in a wall of the flexible body 30a, or the temperature adjusting element 60a is located on an inner wall of the flexible body 30a, or the temperature adjusting element 60a is arranged in the massaging portion 32a, or the temperature adjusting element 60a is arranged on an outer wall of the flexible body 30a. The temperature adjusting element 60a may be embedded in the wall of the flexible body 30a by an injection molding process. The outer wall of the flexible body 30a defines a groove, and the temperature adjusting element 60a may be received in the groove. Optionally, the temperature adjusting element 60a is at least one of a heating coil, a semiconductor refrigeration sheet, and a heating rod. The temperature adjusting element 60a can heat or cool the flexible body 30a, thereby improving the massaging effect. Understandably, the flexible body 30a can be heated or cooled during massaging or before massaging. In one embodiment, the temperature adjusting element 60a is a heating rod, and the heating rod is arranged on an inner wall 121a of the upper cover 12a and extended into the massaging portion 32a, and the flexible body 30a can be heated by the heating rod before massaging.

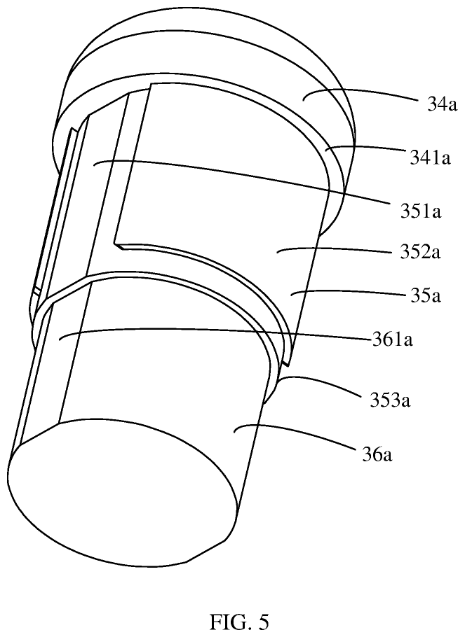

Referring to FIGS. 5-8, the massaging device 100a further includes a support 37a which includes a first support part 371a and a second support part 372a connected with the first support part 371a. The first support part 371a includes a first step 3711a, and the flexible body 30a is arranged on the first step 3711a. The second support part 372a includes a second step 3721a, and the second step 3721a is arranged on the inner housing 20a to connect the support 37a with the inner housing 20a.

The flexible body 30a includes a first flexible part 34a, a second flexible part 35a, and a third flexible part 36a connected in sequence. The size of the first flexible part 34a is larger than that of the second flexible part 35a, so that a third step 341a is formed at the connection of the first flexible part 34a and the second flexible part 35a. The third step 341a is arranged on the upper end of the first support part 371a, the lower end of the second flexible part 35a is arranged on the first step 3711a, so as to arrange the flexible body 30a on the support 37a. The upper end of the first support part 371a is provided with a rib 3714a protruded from the inner wall of the first support part 371a, a mounting part 3715a vertically extended upwards from the rib 3714a, and a fixing portion 3716a protruded from the mounting part 3715a. The fixing portion 3716a protrudes from the edge of the first support part 371a, so that the fixing portion 3716a can extend into the first flexible part 34a, to fix the flexible body 30a on the support 37a. In one embodiment, the number of each of the extension rib 3714a, the mounting part 3715a, and the fixing part 3716a is two.

The first support part 371a and the second support part 372a are arc-shaped. The first flexible part 34a, the second flexible part 35a, and the third flexible part 36a are also arc-shaped. The second flexible part 35a is received in the first support part 371a, the inner wall of the first support part 371a is provided with at least one first inclined portion 3712a, the circumference of the second flexible part 35a is provided with at least one second inclined portion 351a, the first inclined portion 3712a is matched with the second inclined portion 351a, so as to increase the connection stability of the flexible body 30a and the support 37a. Specifically, the inclination angle of the first inclined portion 3712a may be 10-45°, preferably 30°; and the inclination angle of the second inclined portion 351a may be 10-45°, preferably 30°. The first inclined portion 3712a extends obliquely from the inside to the outside of the first support part 371a, and first inclined portion 3712a may extend to the edge of the first support part 371a, so as to facilitate the installation of the flexible body 30a into the support 37a. In one embodiment, the number of each of the first inclined portion 3712a and the second inclined portion 351a is two, and the two first inclined portions 3712a are opposite to each other, and the two second inclined portions 351a are also opposite to each other. The first support part 371a further defines a clamping hole 3713a, and the circumference of the second flexible part 35a is protruded with at least one protrusion 352a which is clamped in the clamping hole 3713a. The clamping hole 3713a may be defined between the two first inclined portions 3712a. Specifically, the number of the protrusions 352a is two, and the two protrusions 352a and the two second inclined portions 351a are alternately arranged.

The size of the second support part 372a is smaller than that of the first support part 371a, so that the second step 3721a is formed at the connection between the first support part 371a and the second support part 372a. The size of the third flexible part 36a is smaller than the size of the second flexible part 35a, so that the connection between the second flexible part 35a and the third flexible part 36a forms the fourth step 353a which is arranged on the first step 3711a.

The third flexible part 36a may be received in the second support part 372a, and the inner housing 20a may sleeve on the second support part 372a. The inner wall of the second support part 372a is protruded with at least one third inclined portion 3722a, the circumference of the third flexible part 36a includes at least one fourth inclined portion 361a, and the third inclined portion 3722a is matched with the fourth inclined portion 361a, so as to increase the connection stability of the flexible body 30a and the support 37a. Specifically, the inclination angle of the third inclined portion 3722a may be 10-45°, preferably 30°; and the inclination angle of the fourth inclined portion 361a may be 10-45°, preferably 30°. The third inclined portion 3722a extends obliquely from the inside to the outside of the second support part 372a, and may extend to the edge of the second support part 372a, so as to facilitate the installation of the flexible body 30a into the support 37a. In one embodiment, the number of each of the third inclined portion 3722a and the fourth inclined portion 361a is two, and the two third inclined portions 3722a are opposite to each other, and the two fourth inclined portions 361a are opposite to each other. The bottom wall of the second support part 372a further defines a first receiving groove 3724a.

Referring to FIGS. 2-3 and 9, the driving assembly 40a includes a first driving element 41a, a first transmission element 42a connected to the first driving element 41a, a first movable element 43a (which may be a piston) connected to the inner housing 20a, and a rod shaped connecting element 44a rotatably connected to the first transmission element 42a and the first movable element 43. The driving member 41a is configured to drive the inner housing 20a and the flexible body 30a to reciprocate and rotate by the first transmission element 42a, the first movable element 43a, and the connecting element 44a. The first driving element 41a can be a motor, and an output shaft of the first driving element 41a is connected with the first transmission element 42a to drive the first transmission element 42a to rotate. The driving assembly 40a further includes a sleeve set 45a, the sleeve set 45a includes a protective sleeve 451a and a self-lubricating sleeve 452a received in the protective sleeve 451a, and the first movable element 43a is movably received in the self-lubricating sleeve 452a. The self-lubricating sleeve 452a can reduce the friction between the first movable element 43a and the self-lubricating sleeve 452a due to its lubricating effect, thereby reducing the noise. In addition, the sleeve set 45a can guide and limit the movement of the first movable element 43a, thereby increasing the stability of the driving assembly 40a. The first transmission element 42a may be a gear set.

In order to further increase the stability of the first movable element 43a, the first movable element 43a may also be used as a counterweight, which may be made of metal, such as iron.

Please referring to FIGS. 2-3 and 10, the massaging device further includes a guiding assembly 50a which includes a first guiding element 51a, a first sliding element 52a, and a fixing element 53a. The sliding member 52a may be a pin or the like. The fixing element 53a can be a screw or a bolt, etc. The first guiding element 51a defines a first guiding portion 511a which may be a guiding groove, a guiding hole, a guiding protrusion, a guiding rib, a guiding cavity, or a guiding space, and the first guiding element 51a is spirally or obliquely arranged on the inner housing 20a. The size of the first sliding element 52a is substantially matched with that of the first guiding portion 511a or slightly smaller than that of the first guiding portion 511a. The first sliding element 52a is fixed on the inner wall of the outer housing 10a and slidably accommodated in the first guiding portion 511a. The fixing element 53a is used to fix the first sliding element 52a on the outer housing 10a. The fixing element 53a may be a screw, a bolt, etc. The inner housing 20a is rotatably connected with the first movable element 43a. When the inner housing 20a brings the first guiding element 51a to reciprocate, the first sliding element 52a interacts with the groove wall of the first guiding portion 511a to enable the first guiding element 51a to slide relative to the first sliding element 52a. The first guiding element 51a brings the inner housing 20a and the flexible member 30a to rotate simultaneously. The first guiding element 51a and the inner housing 20a may be integrally formed, or the first guiding element 51a may be detachably arranged on the inner housing 20a.

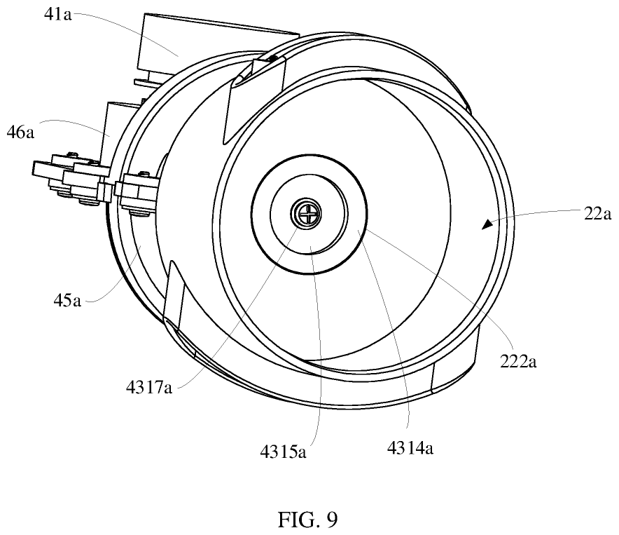

Referring to FIGS. 9-13, the inner housing 20a includes a first connecting part 21a, and the first movable element 43a includes a second connecting part 431a. The first connecting part 21a is rotatably connected with the second connecting part 431a, so that the inner housing 20a is rotatably connected with the first movable element 43a.

The bottom wall of the receiving cavity 22a of the inner housing 20a defines a first through hole 221a and a second receiving groove 222a communicated with the first through hole 221a. The first connecting part 21a defines a second through hole 211a communicated with the first through hole 221a. The outer wall of the first connecting part 21a is protruded with a rotating part 212a. The inner wall of the second through hole 211a is further protruded with a protrusion 213a, the protrusion 213a and the inner wall of the second through hole 211a cooperatively enclose a third receiving groove (not labeled).

The second connecting part 431a is protruded with a connecting column 4311a, and the connecting column 4311a defines a connecting hole 4312a. The second connecting part 431a further includes a first sub connecting portion 4313a and a second sub connecting portion 4316a. The first sub connecting portion 4313a is protruded with a flange 4314a, and the size of the flange 4314a is larger than that of the first through hole 221a. The first sub connecting portion 4313a further defines a groove 4315a. A part of the first sub connecting portion 4313a is received in the second through hole 211a, and the flange 4314a extends into the receiving cavity 22a and received in the second receiving groove 222a, so as to connect with the inner housing 20a. The second sub connecting portion 4316a may be a shaft sleeve, the second sub connecting portion 4316a is connected with the end of the first sub connecting portion 4313a far from the first opening 31a, or is spaced apart with the end of the first sub connecting portion 4313a far from the first opening 31a. The connecting column 4311a is received in the second sub connecting portion 4316a, a part of the fixing part 4317a is received in the groove 4315a, and another part is received in the connecting hole 4312a of the connecting column 4311a after passing through the first sub connecting portion 4313a and the second sub connecting portion 4316a, so as to connect the inner housing 20a with the first movable element 43a. Preferably, the first sub connecting portion 4313a is rotatably connected with the inner housing 20a.

The first movable element 43a defines a third through hole 4301a, the inner wall of the third through hole 4301a is recessed with at least one via hole 4302a and at least one groove 4303a, and a stopping wall 4304a is arranged in the groove 4303a. The rotating part 212a can be received in the groove 4303a after passing through the via hole 4302a, and the stopping wall 4304a can be used to limit the rotation range of the rotating part 212a. Specifically, there are two via holes 4302a, two grooves 4303a, two stopping walls 4304a, and two rotating parts 212a.

When the second support part 372a is received in the receiving cavity 22a, the first receiving groove 3724a of the second support part 372a corresponds with the fixing part 4317a and the flange 4314a, to prevent the bottom wall of the second support part 372a from interfering with the fixing part 4317a and the flange 4314a.

The third through hole 4301a of the first movable element 43a is internally provided with a support column 432a, and the end of the support column 432a far away from the inner housing 20a is protruded with a protrusion 4321a, and defines a notch 4322a. The connecting element 44a may extend into the third through hole 4301a and the notch 4322a to connect with the protrusion 4321a.

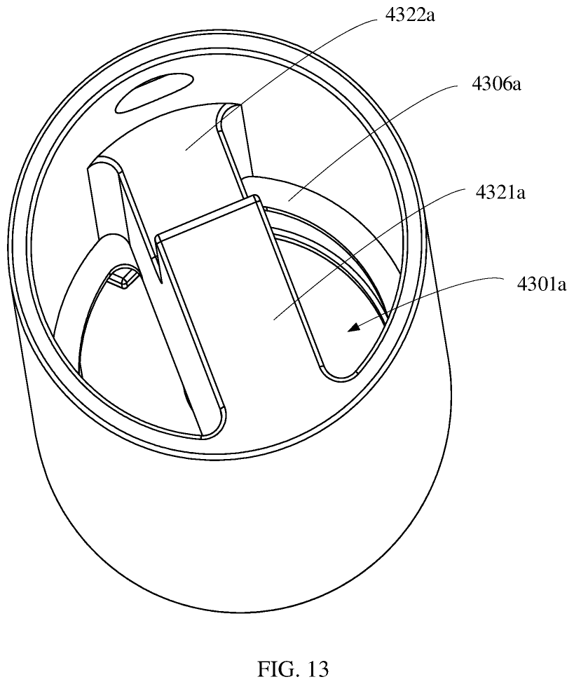

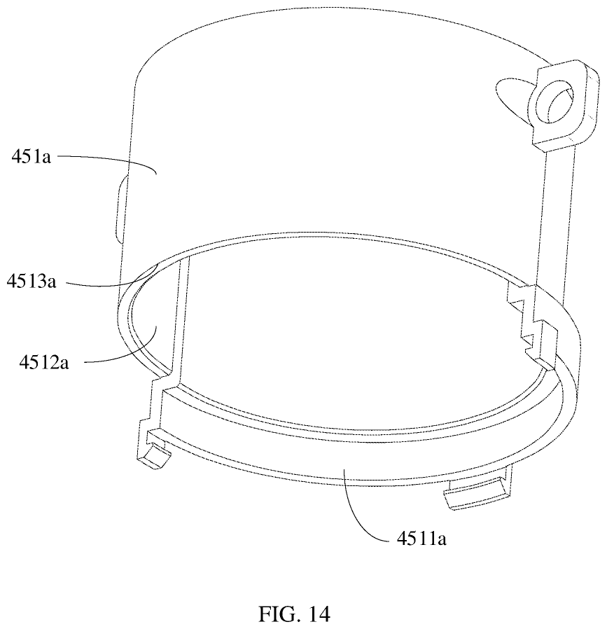

Referring to FIGS. 14-16, the massaging device 100a further includes a mounting frame 46a which includes a first mounting part 461a and a second mounting part 462a connected to the first mounting part 461a. The first mounting part 461a is used for mounting the sleeve set 45a. The first transmission element 42a is mounted on a side of the second mounting part 462a, and the first driving element 41a is mounted on the other side of the second mounting part 462a. The output shaft of the first driving element 41a is connected with the first transmission element 42a after passing through the second mounting part 462a.

The first mounting part 461a is substantially arc shaped. The first mounting part 461a is internally protruded with a fifth step 4611a arranged in a radial direction of the first mounting part 461a. The outer surface of the first mounting part 461a is protruded with a sixth step 4612a. The protective sleeve 451a is protruded with a convex portion 4511a, and the inner wall of the protective sleeve 451a defines a concave portion 4512a. The first mounting part 461a extends into the protective sleeve 451a and is received in the concave portion 4512a. The convex portion 4511a is arranged on the fifth step 4611a. The edge 4513a of the convex part 4511a and is arranged on the sixth step 4612a, to connect the first mounting part 461a with the protective sleeve 451a.

One side of the second mounting part 462a is provided with a first sub mounting portion 4621a matched with the first driving element 41a in shape and used to mount the first driving element 41a. The other side of the second mounting part 462a is provided with a second sub mounting portion 422a matched with the first transmission element 42a in shape and used to mount the first transmission element 42a. The second mounting part 462a further defines a through hole 4623a. The output shaft of the first driving element 41a is connected with the first transmission element 42a after passing through the through hole 4623a.

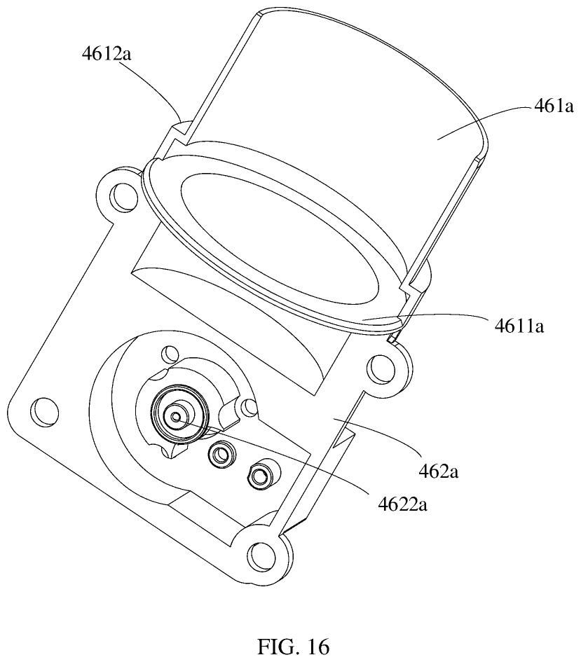

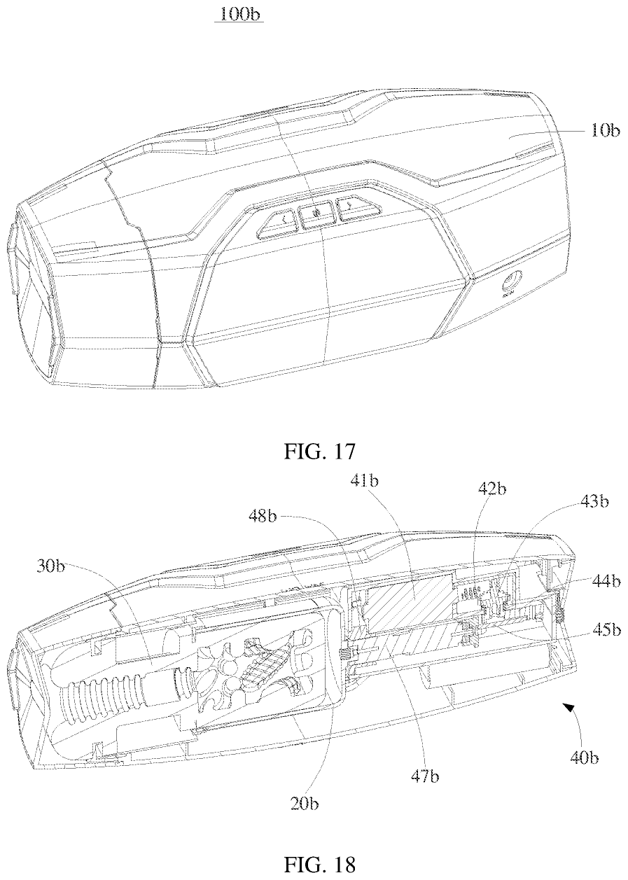

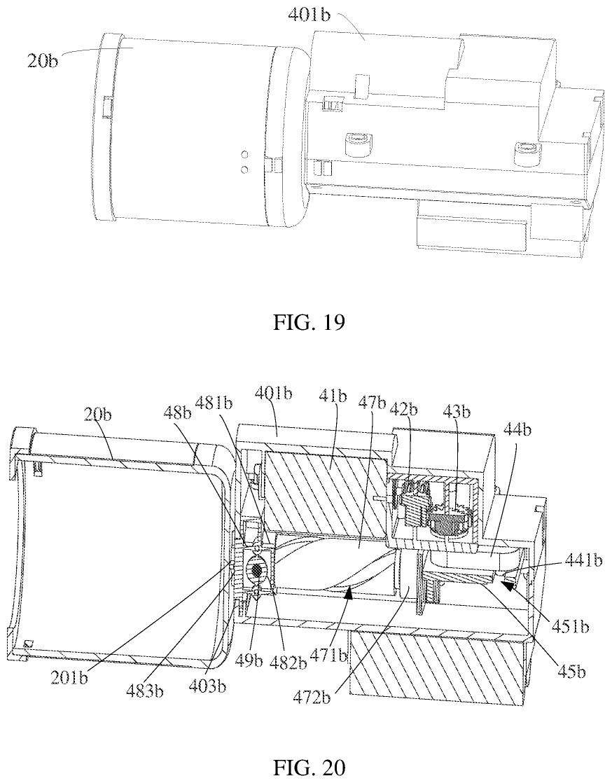

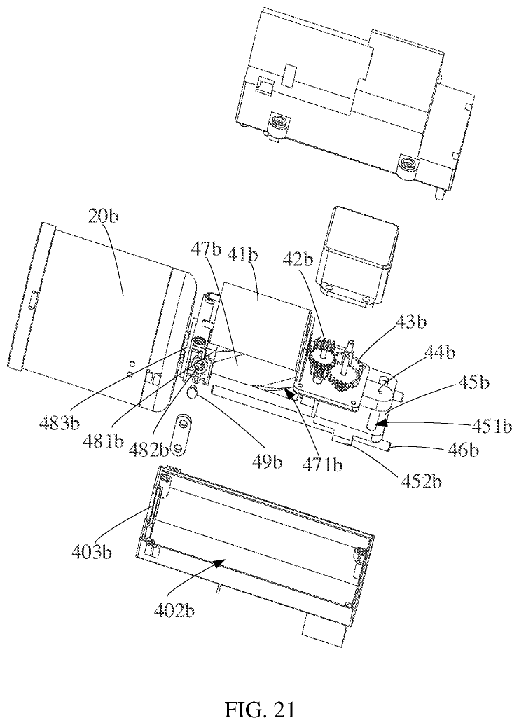

Referring to FIGS. 17-21, the present disclosure further provides a massaging device 100b according to a third embodiment. The massaging device 100b is similar to the massaging device 100a in structure, and the differences between the two devices at least include: the driving assembly 40b includes a second driving element 41b, a worm gear 42b connected with the second driving element 41b, a second gear set 43b connected with the worm gear 42b, a rod-shaped first swing element 44b connected with the second gear set 43b, a second movable element 45b connected with the first swing element 44b and defining a second guiding portion 451b, at least one guiding rod 46b for guiding a movement of the second movable element 45b, a second guiding element 47b connected with the second driving element 41b and defining a second guiding portion 411b, and a mounting element 48b connected with the inner housing 20b and defining a mounting portion 481b, and a second sliding element 49b fixed in the mounting portion 481b and contacted with the second guiding portion 411b. The second driving element 41b is configured to drive the worm gear 42b and the second gear set 43b to rotate, is configured to move the second movable element 45b to reciprocate due to an interaction between the first swing element 44b and the second guiding portion 451b, further to move the inner housing 20b, the flexible body 30b, and the second guiding element 47b to reciprocate simultaneously. The worm gear 42b and the second gear set 43b may be regarded as components of a transmission element. The second guiding element 47b may be a screw rod. The second guiding portion 451b may be a guiding groove, a guiding hole (including a through hole or a blind hole), a guiding cavity, a guiding protrusion, a guiding rib, or a guiding space. The worm gear 42b and second gear set 43b may be regarded as a part of a second transmission element.

The driving assembly 40b is received in a mounting member 401b. In detail, the mounting member 401b defines a receiving portion 402b and a through hole 403b communicated with the receiving portion 402. The second driving element 41b, the worm gear 42b, the second gear set 43b, the first swing element 44b, the second movable element 45b, the at least one guiding rod 46b, the second guiding element 47b, and the mounting element 48b are received in the receiving portion 402b. The mounting element 48b includes a first mounting part 481b for mounting the second guiding element 47b, a second mounting portion 482b for mounting the second sliding element 49b, and a connecting portion 483b for connecting with the inner housing 20b. The connecting portion 483b passes through the through hole 403b and connects with the inner housing 20b, and the inner housing 20b is rotatably connected with the connecting portion 483b.

One end of the second guiding element 47b is rotatably connected with the second movable element 45b by a bearing 472b, and the other end of the second guiding element 47b is rotatably and slidably connected with the first mounting part 481b. In detail, the mounting element 48b defines a via hole (not labeled), the second guiding element 47b is rotatably and slidably passed through hole the via hole to connect with the inner housing 20b. The third guiding portion 471b is spirally or obliquely arranged on the second guiding element 47b. A part of the second sliding element 49b is fixed in the second mounting portion 482b, and another part of the second sliding element 49b is extended in the third guiding portion 471b, when the second guiding element 47b reciprocate, the second sliding element 49b acts with the third guiding portion 471b to rotate the second guiding element 47b, further to rotate the inner housing 20b and the flexible body 30b.

The second guiding element 47b is arranged on same sides of the second driving element 41b, the worm gear 42b, and the second gear set 43b.

The second sliding element 49b may be a screw, a bolt, etc.

The second movable element 45b includes at least one connecting part 452b, the at least one guiding rod 46b is movably connected with the connecting part 452b, so the second movable element 45b may slide along the at least one guiding rod 46b. T connecting part 452b may include a through hole, the at least one guiding rod 46b is received in the through hole.

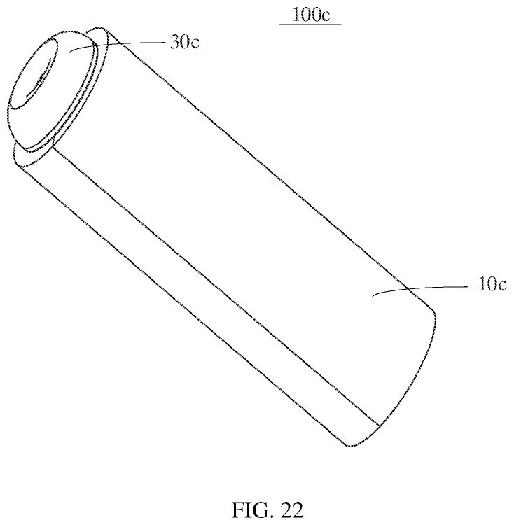

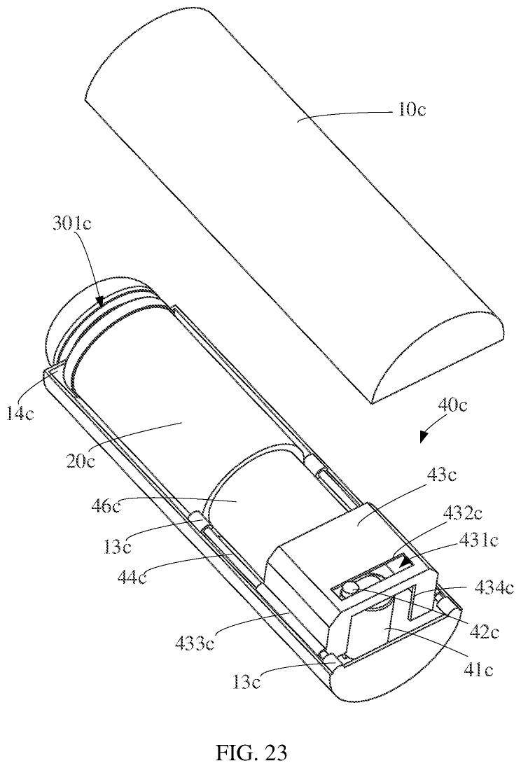

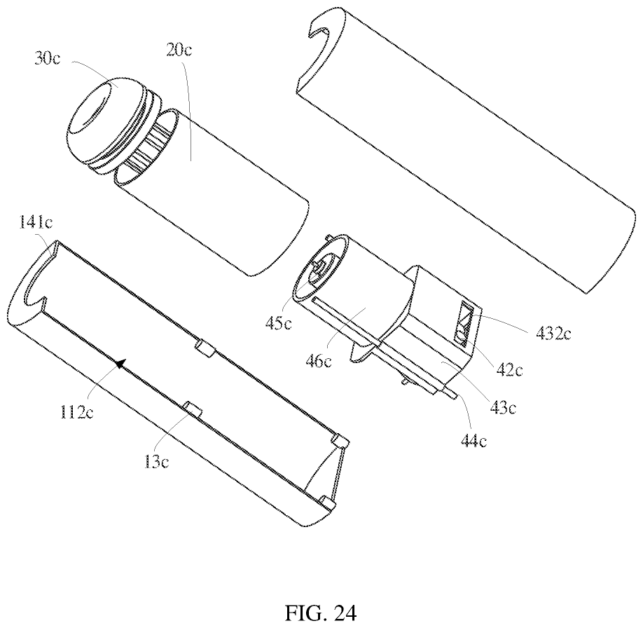

Referring to FIGS. 22-24, the present disclosure further provides a massaging device 100c according to a third embodiment. The massaging device 100c is similar to the massaging device 100a in structure, and the differences between the two devices at least include: the outer housing 10c includes a fourth opening 111c and a receiving space 112c communicated with the fourth opening 111c, the flexible body 30c is partially received in the receiving space 112c and exposed from the second opening 111c; the driving assembly 40c includes a third driving element 41c, a rod-shaped second swing element 42c connected with the third driving element 41c, a third movable element 43c connected with the second swing element 42c, at least one guiding rod 44c for guiding a movement of the third movable element 43c, a fourth driving element 45c connected with the inner housing 20c, a mounting element 46c for mounting the fourth driving element 45c on the third movable element 43c, the third movable element 43c defines a receiving portion 431c and a third guiding portion 432c communicated with the receiving portion 431c, the third driving element 41c is received in the receiving portion 431c, and the second swing element 42c is received in the third guiding portion 432c. The inner housing 20c is rotatably connected with the mounting element 46c. The third driving element 41c is configured to drive the third movable element 43c to reciprocate due to an interaction between the second swing element 42c and the third guiding portion 432c, further to move the inner housing 20c, the flexible body 30c, the mounting element 46c, and the fourth driving element 45c to reciprocate simultaneously. The output shaft of the fourth driving element 45c is connected with the inner housing 20c, and is configured to drive the inner housing 20c to rotate, so as to bring the flexible body 30c to rotate simultaneously.

The third guiding portion 432c may be a guiding groove, a guiding hole (including a through hole or a blind hole), a guiding cavity, a guiding protrusion, a guiding rib, or a guiding space.

The outer housing 10c includes at least one first mounting portion 13c, the third movable element 43c includes at least one second mounting portion 433c, the at least one guiding rod 44c is mounted on the first mounting portion 13c, and the at least one second mounting portion 433c is slidably mounted on the at least one guiding rod 44c, for guiding the movement of the third movable element 43c.

The receiving portion 431c may be a receiving cavity, a receiving space.

The third movable element 43c further defines a via hole 434c communicated with the receiving portion 431c, when the third movable element 43c is configured to move towards, the third driving element 41c is exposed from the third movable element 43c by the via hole 434c, so the third driving element 41c may not interfere in the movement of the third movable element 43c.

There is a gap 301c defined between the flexible body 30c and the inner housing 20c, a top plate 14c is received in the gap 301c, to connect the outer housing 10c with the flexible body 30c and the inner housing 20c.

The above description is merely some embodiments. It should be noted that for one with ordinary skills in the art, improvements can be made without departing from the concept of the present disclosure, but these improvements shall fall into the protection scope of the present disclosure.

What is claimed is:

1. A massaging device, comprising:
a flexible body, defining a first opening and a massaging portion communicated with the first opening; and
a driving assembly, configured to drive the flexible body to reciprocate and rotate simultaneously.

2. The massaging device of claim 1, further comprising:
an inner housing, connected between the flexible body and the driving assembly, and the driving assembly is configured to drive the flexible body to reciprocate and rotate by the inner housing.

3. The massaging device of claim 2, wherein the driving assembly comprises:
a first driving element;
a first transmission element, connected with the first driving element; and
a first movable element, connected with the inner housing and the first transmission element, the first driving element is configured to drive the first movable element to reciprocate by the first transmission element, further to enable the flexible body and the inner housing to reciprocate.

4. The massaging device of claim 3, wherein the driving assembly further comprises:
a connecting element, configured to connect the first movable element with the first transmission element.

5. The massaging device of claim 3, wherein the movable element is a counterweight made of metal.

6. The massaging device of claim 3, further comprising:
an outer housing;
a first guiding element, arranged on the inner housing and comprising a first guiding portion, the first guiding portion is spirally or obliquely arranged on the first guiding element; and
a first sliding element, fixed on the outer housing and connected with the first guiding portion, when the inner housing and the first guiding element reciprocate, the first sliding element is configured to rotate the inner housing and the first guiding element due to an interaction between the first sliding element and the first guiding portion, so that the inner housing and the flexible body reciprocate and rotate simultaneously.

7. The massaging device of claim 6, further comprising:
a fixing element, configured to fix the first sliding element on the outer housing.

8. The massaging device of claim 6, wherein the first guiding element is detachably arranged on the inner housing; or the first guiding element is integratedly formed with the inner housing.

9. The massaging device of claim 6, wherein
the inner housing comprises a first connecting part; and
the first movable element comprises a second connecting part, the first connecting part is rotatably connected with the second connecting part, to rotatably connect the inner housing with the movable element.

10. The massaging device of claim 2, further comprising:
a support, comprising:
a first support part, configured to support the flexible body; and
a second support part, connected with the first support part, the second support part is connected with the inner housing, to connect the inner housing with the flexible body.

11. The massaging device of claim 1, wherein the flexible body further comprises at least one massaging protrusion received in the massaging portion, a cross section of the at least one massaging protrusion is substantially cylindrical shaped, trapezoid shaped, triangular shaped, arc shaped, or irregular shaped.

12. The massaging device of claim 1, further comprising:
a temperature adjusting element, wherein
the temperature adjusting element is embedded in a wall of the flexible body; or
the temperature adjusting element is arranged on an inner wall of the flexible body; or
the temperature adjusting element is arranged on an outer wall of the flexible body.

13. The massaging device of claim 1, wherein the driving assembly comprises:
a second driving element;
a first swing element, connected with the second driving element; and
a second movable element, connected with the first swing element and defining a second guiding portion, the first swing element is slidably connected with the second guiding portion, the second driving element is configured to drive the first swing element to rotate, and the first swing element is configured to reciprocally move the second movable element due to an interaction between the first swing element and the second guiding portion.

14. The massaging device of claim 13, wherein the driving assembly further comprises:
a mounting element;
a second guiding element, defining a third guiding portion, the third guiding portion is spirally or obliquely arranged on the second guiding element; and
a second sliding element, fixed to the mounting element and connected with the third guiding portion, the movable element is configured to reciprocally move the second guiding element, and the second sliding element is configured to rotate the second guiding element due to an interaction between the third guiding portion and the second sliding element, so that the inner housing and the flexible body reciprocate and rotate simultaneously.

15. The massaging device of claim 14, wherein the second guiding element is rotatably connected between the mounting element and the movable element, and a portion of the second guiding element is configured to pass through the mounting element to connect with the inner housing.

16. The massaging device of claim 14, wherein the driving assembly further comprises a second transmission element, the second transmission element comprises:
a worm gear, connected with the second driving element; and
a gear set, connected with the worm gear and the first swing element, the second guiding element is arranged on same sides of the second driving element, the worm gear, and the gear set.

17. The massaging device of claim 1, wherein the driving assembly comprises:
a third driving element;
a second swing element, connected with the third driving element;
a third movable element, connected with the second swing element and defining a third guiding portion, the second swing element is slidably connected with the third guiding portion; and
a fourth driving element, connected with the inner housing, the third driving element is configured to drive the third movable element to reciprocate due to an interaction between the second swing element and the third guiding portion, further to reciprocally move the inner housing and the flexible body, the fourth driving element is configured to drive the inner housing and the flexible body to rotate, so that the inner housing and the flexible body reciprocate and rotate simultaneously.

18. The massaging device of claim 17, wherein third movable element defines:
a receiving portion, communicated with the third guiding portion; and
a via hole, communicated with the receiving portion, the third driving element is received in the receiving portion and exposed from the third movable element by the via hole.

19. The massaging device of claim 1, further comprising:
an outer housing, defining a second opening, the flexible body is at least partially exposed from the outer housing by the second opening, and the driving assembly is received in the outer housing.

20. The massaging device of claim 19, wherein
the outer housing further comprises a top plate defining the second opening; and
a gap is defined between the flexible body and the inner housing, the top plate is received in the gap, to connect the outer housing with the flexible body and the inner housing.
